(19) United States
(12) Patent Application Publication
(10) Pub. No.: US 2014/0377063 A1
(43) Pub. Date: Dec. 25, 2014

(54) WIND POWER PLANT HAVING A SLIDING BEARING

(71) Applicant: Siemens Aktiengesellschaft, Munich (DE)

(72) Inventors: Pierre-Antoine Guerenbourg, Vejle (DK); Bo Pedersen, Lemvig (DK); Kim Thomsen, Ikast (DK)

(73) Assignee: Siemens Aktiengesellschaft, Munich (DE)

(21) Appl. No.: 14/304,900

(22) Filed: Jun. 14, 2014

(30) Foreign Application Priority Data
Jun. 20, 2013 (DE) 102013211710.8

(51) Int. Cl. F03D 11/00; F16C 17/04; F16C 33/04; F16C 17/02

(52) U.S. Cl. CPC F03D 11/0008; F16C 17/02; F16C 17/04; F16C 33/04
USPC 416/1; 384/276; 384/291; 416/174

(57) ABSTRACT

A wind power plant having a sliding bearing with a first and second bearing component which are arranged to rotate relative to one another about a common rotational axis is provided. The sliding bearing has at least one sliding lining arranged between the first and second bearing component and has a contact face with a lubricant. The contact face has a sliding lining duct opening to a sliding lining duct, wherein the sliding lining duct crosses the sliding lining and feeds lubricant into a region between the first and second bearing component. The sliding lining has a groove on the contact face, surrounding the sliding lining duct opening. An operation of the wind power plant to generate electric current is also provided. The sliding bearing operates hydrostatically during a startup phase of the rotational movement and/or operates hydrodynamically during a phase of the rotational movement with a constant rotational speed.

### CROSS REFERENCE TO RELATED APPLICATIONS

This application claims the benefit of German Application No. DE 102013211710.8 filed Jun. 20, 2013. All of the applications are incorporated by reference herein in their entirety.

### FIELD OF INVENTION

The invention relates to a wind power plant having a sliding bearing and to an operation of the wind power plant in order to generate electric current.

### BACKGROUND OF INVENTION

A wind power plant is typically intended to be in operation or operationally capable and to generate electric current efficiently for many years, preferably for a number of decades. The requirements in terms of maintenance capability and robustness of the wind power plant are high here. This applies, in particular, to so-called offshore wind power plants, i.e. wind power plants which are installed in water, for example in the sea. Maintenance of offshore wind power plants is often costly owing to the difficulty of access.

Typical wearing parts of a wind power plant are the bearings. At present, roller bearings with rollers and/or rolling bearings with drums are widely used in wind power plants. It is costly to replace the rollers or drums which the roller bearing or rolling bearing has. The drive train of the wind power plant must often be disassembled completely or at least partially. This is generally possible only by means of a crane. However, in particular in the case of an offshore wind power plant the use of such a crane is expensive and costly.

An alternative to a roller bearing or a rolling bearing is, for example, a sliding bearing. In this context, in particular a hydrodynamic sliding bearing and a hydrostatic sliding bearing are possible. It is generally easier to replace the wearing parts, in this case in particular the sliding linings, than to replace the rollers or drums in roller bearings or rolling bearings.

However, the use of sliding bearings in a wind power plant has specific problems: in the case of a hydrodynamic bearing, a high initial torque is necessary if the bearing is to be made to rotate from the stationary state under load owing to gravitation and/or wind. Hydrostatic bearings in which a lubricant is under high pressure have the disadvantage that they require a continuous power supply for a pump system which constitutes, on the one hand, a potential risk of failure and, on the other hand, continuously requires energy, i.e. current.

### SUMMARY OF INVENTION

An object of the invention is therefore to disclose how a sliding bearing of a wind power plant can be improved. Specifically, a lubricant for operating the sliding bearing is to be fed in as efficiently as possible.

This object is achieved according to the independent claims. Advantageous developments are disclosed in the dependent claims.

In order to achieve this object, a wind power plant having a sliding bearing is disclosed, wherein the sliding bearing comprises a first bearing component and a second bearing component. The first bearing component and the second bearing component are arranged such that they can rotate relative to one another about a common rotational axis. The sliding bearing has at least one sliding lining which is arranged between the first bearing component and the second bearing component. The sliding lining has a contact face which is provided for contact with a lubricant. The contact face has a sliding lining duct opening to a sliding lining duct, wherein the sliding lining duct crosses the sliding lining and is provided for feeding lubricant into a region between the first bearing component and the second bearing component. Finally, the sliding lining has a groove on the contact face, and the groove surrounds the sliding lining duct opening.

A wind power plant can convert wind energy into electrical energy. A wind power plant is also referred to as a wind energy plant, wind turbine plant or wind power convertor.

The first bearing component and/or the second bearing component are advantageously in the form of a hollow cylinder. The hollow cylinder can have a circular circumference. In other words, the first bearing component and/or the second bearing component are in the form of a disk with an opening or a hole.

The wind power plant advantageously has a tower, a gondola with a machine frame, a generator and a rotor with a hub. At least one rotor blade, preferably at least two rotor blades, normally preferably precisely three rotor blades, is/are attached to the hub.

In a first alternative, the first bearing component is mechanically connected to the rotor, and the second bearing component is mechanically connected to the machine frame. In a second alternative, the first bearing component is mechanically connected to the machine frame, and the second bearing component is mechanically connected to the rotor. In both alternatives, the first bearing component and the second bearing component are mounted or arranged such that they can rotate relative to one another, in particular about a common coaxial rotational axis.

The rotor is advantageously connected to a generator rotor, which can also be referred to as a rotor part of the generator.

A space between the first bearing component and/or the second bearing component can be referred to as a bearing inner space. The sliding lining is advantageously located in the bearing interior space. The sliding lining preferably has a square shape. Furthermore, the sliding lining can advantageously have an attachment face which is opposed to the contact face and arranged parallel thereto. In advantageous embodiments, the attachment face is directly connected to the first bearing component, the second bearing component and/or a sliding lining carrier.

A function of the sliding lining duct is to feed a lubricant from the outside into the region between the first bearing component and the second bearing component, that is to say for example to the bearing inner space.

A decisive feature of the wind power plant according to the invention is the groove which the sliding lining has on the contact face. A sliding lining whose contact face has a groove with a sliding lining duct opening can cover a larger surface with lubricant than a conventional sliding lining which has a sliding lining duct opening of the same size but no groove. In a startup phase of the sliding bearing, that is to say when the sliding bearing is starting up from the stationary state, the groove can function as a support for the hydrostatic operation. If, for example, a lubricant is pressed onto the contact face by the sliding lining duct, friction, which occurs in the startup phase of the sliding bearing in the hydrostatic operating mode owing to the wetted surface in the groove, can be reduced compared to a sliding lining which only has a sliding lining duct opening and no groove. In the hydrodynamic operating mode, i.e. in an operating mode with, for example, constant rotational speed of the sliding bearing, the force or the pressure to be applied can also be reduced by the groove. As a result a hybrid, i.e. hydrostatic/hydrodynamic, sliding bearing is possible.

The contact face can have one longitudinal side and one transverse side. The transverse side is, for example, of precisely the same length as the longitudinal side, i.e. the contact face is square. In one advantageous embodiment, the longitudinal side is between 100 and 200 times longer than a depth of the groove. The depth of the groove is advantageously between 1 mm and 20 mm, in particular between 5 mm and 10 mm.

In one preferred embodiment, the sliding bearing is a radial bearing and/or an axial bearing.

A radial bearing, also referred to as a transverse bearing or supporting bearing, prevents or impedes movement of the first bearing component and/or of the second bearing component in the radial direction, that is to say essentially perpendicularly with respect to the axial direction. An axial bearing, also referred to as a longitudinal bearing, pressure bearing or pivot bearing, prevents or impedes movement of the first bearing component and/or of the second bearing component in the axial direction. The combination of the radial bearing and axial bearing is referred to as a radiax bearing. An example of a radiax bearing is a simple-acting radial bearing which is supplemented by two axially acting bearing pairs. Another advantageous example of a radiax bearing is a toe bearing, also referred to as a jewel bearing, in which a multiplicity of toe pairings are located opposite one another and are formed, for example, in the shape of a truncated cone.

If the sliding bearing is a radial bearing, the first bearing component advantageously is in the form an outer bearing ring, and the second bearing component is advantageously in the form of an inner bearing ring. The sliding lining is then advantageously attached to an outer side of the inner bearing ring and/or to an inner side of the outer bearing ring.

In a first alternative, the inner bearing ring is mechanically connected to the machine frame, and the sliding lining is attached to the outside of the inner bearing ring. In a second alternative, the outer bearing ring is mechanically connected to the machine frame, and the sliding lining is attached to the inside of the outer bearing ring. In a third alternative, the inner bearing ring is mechanically connected to the rotor, and the sliding lining is attached to the outside of the inner bearing ring. Finally, in a fourth alternative, the outer bearing ring is mechanically connected to the rotor, and the sliding lining is connected to the inside of the outer bearing ring.

If the sliding bearing is an axial bearing, the first bearing component and the second bearing component are both in the form of a bearing washer. Both bearing washers can have a similar shape and size. Both bearing washers are advantageously arranged offset axially from one another, wherein the first bearing washer faces, for example, a hub of the wind power plant, and the second bearing washer faces a generator of the wind power plant.

In one advantageous embodiment, the sliding bearing has a rotational direction which is defined by the first bearing component and second bearing component which can rotate relative to one another. Furthermore, the contact face has a contact face region at the front in the rotational direction, and a contact face region at the rear in the rotational direction. The groove is located in the front contact face region.

The rotational direction relates to a rotation of the first bearing component and of the second bearing component about the common rotational axis.

In a first alternative, the contact face is divided in halves, into the front contact face region and into the rear contact face region. In a second alternative, the contact face has a central contact face region and the contact face is divided, for example into thirds comprising the front contact face region, the central contact face region and the rear contact face region, respectively.

An arrangement of the groove in the front contact face region has multiple advantages. On the one hand, a reduction in the friction is greater in the hydrostatic operating mode of the sliding bearing if the groove is located in the front contact face region compared to a groove in the rear contact face region. On the other hand in the hydrodynamic operating mode of the sliding bearing a groove in the front contact face region is advantageous since the region of the contact face which is “grooveless”, that is to say, for example, planar, is enlarged compared to, for example, a sliding bearing with a groove in the central region of the contact face. This is due, inter alia, to the fact that a continuous grooveless face is advantageous for building up a hydrodynamic pressure.

The groove can have the shape of a semicircle in a cross section perpendicular to a longitudinal extent of the groove and perpendicular to the contact face. Likewise, the cross section of the groove can have a triangle. Other shapes such as, for example, half of an ellipse, can be advantageous. With respect to the shape of the groove, hydrodynamic/hydrostatic criteria and simplicity in manufacture have to be balanced against one another.

In one advantageous embodiment, the groove has a groove wall at the front in the rotational direction and a groove wall at the rear in the rotational direction. The front groove wall has a front groove wall inclination angle between the front groove wall and the contact face, and the rear groove wall has a rear groove wall inclination angle between the rear groove wall and the contact face. Furthermore, the front groove wall inclination angle is smaller than the rear groove wall inclination angle.

If the contact face is, for example, a planar face and the groove has in cross section the shape of a semicircle the front groove wall inclination angle and the rear groove wall inclination angle are each 90°. A front groove wall inclination angle which is less than a rear groove wall inclination angle, which can also be referred to as a beveled edge, beveled face or chamfer, has multiple advantages. Firstly, if there is contact between the contact face and the opposite side of the bearing inner space in the stationary state of the sliding bearing, the beveled face can enlarge the face which is covered with pressurized lubricant. As a result, a hydrostatic capacitance, that is to say power of the sliding bearing, can be increased with the same lubricant injection pressure compared to a sliding bearing without a beveled face. On the other hand, in an operating state in which the sliding bearing has a constant rotational speed, the beveled face permits the lubricant to penetrate better between the contact face and the face which lies opposite in the bearing inner space than in a comparable sliding lining without a beveled face. As a result, the beveled edge also permits, for example, the hydrodynamic operating pressure to be reached more quickly.

In a further embodiment, the sliding bearing has a sliding lining carrier which is connected to the sliding lining. Furthermore, the sliding lining carrier has a sliding lining carrier duct which crosses the sliding lining carrier, wherein the sliding lining carrier duct is provided for feeding lubricant into the sliding lining duct.

The sliding lining carrier can be connected in one piece with the sliding lining. The sliding lining carrier can also be connected to the sliding lining by at least one screw, a bolt and/or a nail. The connection between the sliding lining and the sliding lining carrier is advantageously configured in such a way that in the case of wear of the sliding lining the sliding lining can be replaced with little effort.

The sliding lining carrier duct and the sliding lining duct can be in the form of a round cylinder. The sliding lining carrier duct and/or the sliding lining duct can have an internal diameter in a range between 1 mm and 15 mm, in particular in a range between 2 mm and 10 mm.

In a further embodiment, the sliding lining carrier is arranged, by a rotary joint, such that it can rotate relative to the first bearing component and/or can rotate relative to the second bearing component.

The rotary joint can be a mechanical rotary joint which comprises, for example, a point contact and/or a line contact, with the result that the sliding lining carrier is rotatably mounted with the sliding lining. The rotary joint has the advantage that during operation of the sliding lining the sliding lining can change in its orientation in order, for example, to set a uniform thickness of a lubricant film which is located between the contact face and the opposite face of the bearing inner space.

In a further advantageous embodiment, the sliding lining carrier and/or the sliding lining are/is flexible.

One advantage of a flexible sliding lining and/or sliding lining carrier is that the sliding lining and/or the sliding lining carrier can adapted to an optimum shape and an optimum orientation in the sliding bearing.

Given a certain external load, i.e. an external force with a certain size which acts on the sliding lining carrier, the sliding lining carrier deforms in a range between 0 and 1000 μm (micrometers). This deformation is based on the deformation of the sliding lining carrier which has, for example iron, and on the deformation of the sliding lining which has, for example, a polymer compound. In contrast, the lubricant, for example an oil mixture, is compressed in a range between 0 and 100 μm when the same external force acts. In this example, the flexibility of the sliding lining carrier relative to the compressibility of the lubricant film is therefore significant.

In a further embodiment, the sliding lining carrier comprises a sliding lining carrier material which has iron, in particular an iron alloy.

For example, the sliding lining carrier material has steel and/or cast iron.

In a further advantageous embodiment, the wind power plant has a rotor and a gondola, and the sliding bearing is a main bearing for rotatably bearing the rotor relative to the gondola.

The main bearing of a wind power plant has an internal diameter of up to several meters, in particular an internal diameter in a range between a meter and ten meters. It is advantageous in a bearing of this size to use a sliding bearing instead of conventional roller bearings and rolling bearings since the main bearing can be subjected to very large forces. It may therefore be necessary to operate the sliding bearing with lubricant injection pressure. This involves a high energy requirement for maintaining the lubricant injection pressure. In this regard, a sliding bearing with a sliding lining which has a groove is advantageous since the lubricant injection pressure is reduced and as a result the sliding bearing can be operated economically and efficiently in terms of energy.

In a further embodiment, the lubricant has lubricating oil.

The lubricating oil has here a viscosity which can depend on a temperature of the lubricating oil. The lubricating oil is advantageously selected as a function of the temperature which occurs and a range of a sliding speed, that is to say a rotational speed of the sliding bearing. For example, at high sliding speeds a sliding oil with low viscosity is advantageous. In contrast, at high temperatures a lubricating oil with relatively high viscosity is advantageous since the viscosity of the lubricating oil can decrease at rising temperatures.

In one advantageous embodiment, the sliding lining has a sliding lining material which has a polymer and/or a white metal.

The sliding lining material advantageously has a polymer compound.

The polymer is, for example nylon.

In a further advantageous embodiment, the sliding bearing has a plurality of sliding linings. In the case of a radial sliding bearing, these can be attached to the outside of the inner bearing ring and/or to the inside of the outer bearing ring.

The sliding bearing advantageously has between two and fifty sliding linings, in particular between ten and forty sliding linings. The plurality of sliding linings can be arranged around the periphery, in particular around the circumference.

The invention also relates to an operation of the wind power plant in order to generate electric current. In other words, the invention relates to a use of the wind power plant for generating electric current.

The sliding bearing is advantageously operated hydrostatically during a startup phase of the rotational movement and/or hydrodynamically during a phase of the rotational movement with a constant rotational speed.

If the sliding bearing is operated hydrostatically or hydrodynamically depending on the phase of the rotational movement, the sliding bearing can also be referred to as a hybrid, i.e. hydrostatic/hydrodynamic, sliding bearing. The operation of a wind power plant with a hybrid sliding bearing is efficient with respect to the energy required to force in or inject the lubricant.

### BRIEF DESCRIPTION OF THE DRAWINGS

The invention will be explained below on the basis of a plurality of schematic figures which are not true to scale. Furthermore, exemplary embodiments of the invention are described. In the drawing:

FIG. 1 shows a wind power plant,

FIG. 2 shows a radial sliding bearing with a plurality of sliding linings,

FIG. 3 shows an axial sliding bearing,

FIG. 4 shows a sliding lining with a groove and a sliding lining duct,

FIG. 5 shows a first cross section of a sliding lining with a groove,

FIG. 6 shows a second cross section of the sliding lining,

FIG. 7 shows a cross section of a sliding lining with a groove and a beveled face,

FIG. 8 shows a sliding lining with a sliding lining duct and a sliding lining carrier with a sliding lining carrier duct, and

FIG. 9 shows a sliding lining, a sliding lining carrier and a rotary joint.

### DETAILED DESCRIPTION OF INVENTION

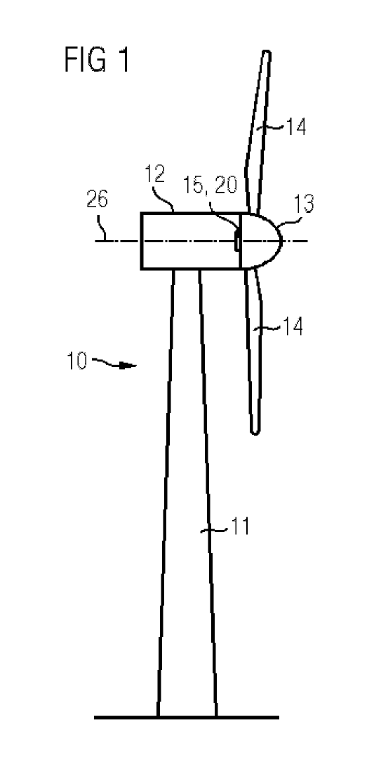

FIG. 1 shows a wind power plant 10 with a tower 11 and a gondola 12. The gondola 12 is mounted such that it can rotate relative to the tower 11 about a vertical rotational axis. The gondola 12 has a machine frame. Furthermore, the wind power plant 10 has a hub 13 which is attached to a rotor. The rotor has a rotational axis 26. The hub 13 is connected to the machine frame of the gondola 12 by a main bearing 15. The main bearing 15 is configured in the wind power plant 10 shown in FIG. 1 as a sliding bearing 20. Finally, the wind power plant 10 also has three rotor blades 14 (two of the three rotor blades 14 are shown in FIG. 1).

The hub 13 with the rotor blades 14 rotates with a rotational speed from 11 revolutions per minute to 15 revolutions per minute about the rotational axis 26. In one alternative exemplary embodiment, the rotational speed can extend up to 20 revolutions per minute.

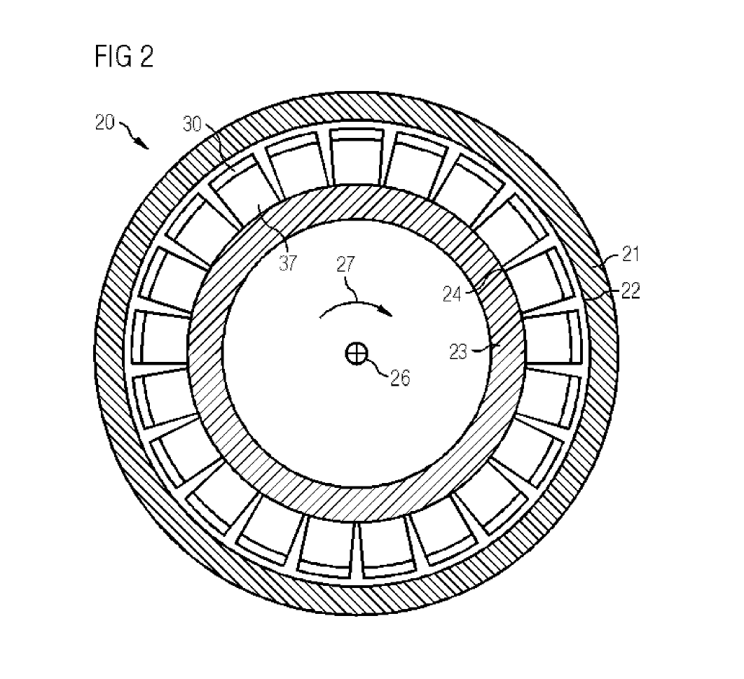

FIG. 2 shows a radial sliding bearing 20 with a plurality of sliding linings 30. In FIG. 2, the plurality of sliding linings 30 has precisely 21 sliding linings 30. The sliding linings 30 are arranged around the circumference.

The sliding bearing comprises a first bearing component 21 which is configured as an outer bearing ring, and surrounds an inner side of the outer bearing ring 22. Furthermore, the sliding bearing surrounds a second bearing component 23 which is configured as an inner bearing ring 23 and surrounds an outer side of the inner bearing ring 24. The two bearing components 21, 23 are each in the shape of a hollow cylinder and are arranged coaxially.

In the exemplary embodiment shown in FIG. 2, the second bearing component 23 is mounted or arranged such that it can rotate relative to the first bearing component 21 with a rotational direction 27 about a rotational axis 26.

The diameter of the inner bearing ring is approximately 1.5 meters. In an alternative exemplary embodiment, the inner bearing ring can have a diameter in the range between 1 meter and 4 meters.

The sliding linings 30 are connected to sliding lining carriers 37. The sliding lining carriers 37 are connected to the outside of the inner bearing ring 24 and are attached thereto. A bearing inner space, which is partially filled with lubricant, is located between the inner bearing ring and the outer bearing ring. The lubricant has lubricating oil, in particular an oil mixture. An average distance between the sliding lining 30 and the inside of the outer bearing 22 is 0.5 mm (millimeters). The lubricating oil at least partially fills this distance.

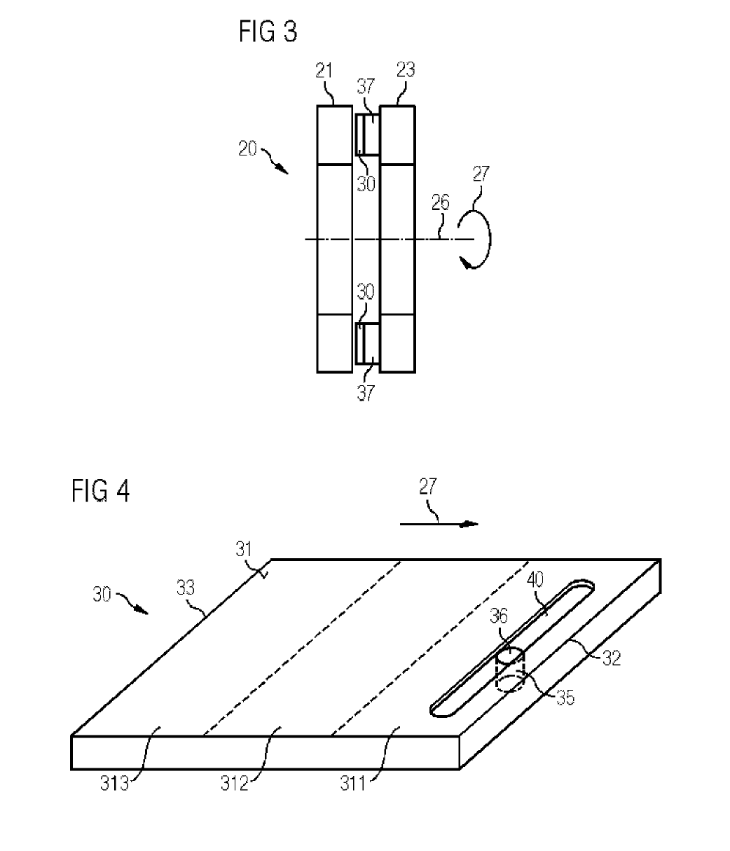

FIG. 3 shows an axial sliding bearing 20. The sliding bearing 20 comprises a first bearing component 21 and a second bearing component 23. The two bearing components 21, 23 are in the form of a washer. A sliding lining carrier 37 with a sliding lining 30 is attached to the second bearing component 23. During operation of the sliding bearing 20, the first bearing component 21 rotates relative to the second bearing component 23 about a rotational axis 26 and as a result defines a rotational direction 27.

FIG. 4 shows a sliding lining 30 with a contact face 31 which is 22 cm (centimeters) times 15 cm in size. The contact face 31 is rectangular and has a front edge 32 which is located at the front in the rotational direction 27 and a rear edge 33 which is parallel thereto. The sliding lining 30 has a thickness of 2 cm. It has nylon.

The contact face has a contact face region 311 which is at the front in the rotational direction 27, a central contact face region 312 and a rear contact face region 313. In the front contact face region 311 there is a groove 40 which is 7 mm deep. Furthermore, the contact face 31 has a sliding lining duct opening 36 which has a diameter of 1 cm. Finally, a sliding lining duct 35 crosses the sliding lining 30.

FIG. 5 shows the first cross section of a sliding lining 30 which has a contact face 31 and an attachment face 34 parallel thereto. Furthermore, the contact face 31 has a front edge 32 and a rear edge 33 (not shown). The cross section is perpendicular to the front edge 32 and to the rear edge 33. A groove 40 can be seen in the first cross section shown in FIG. 4.

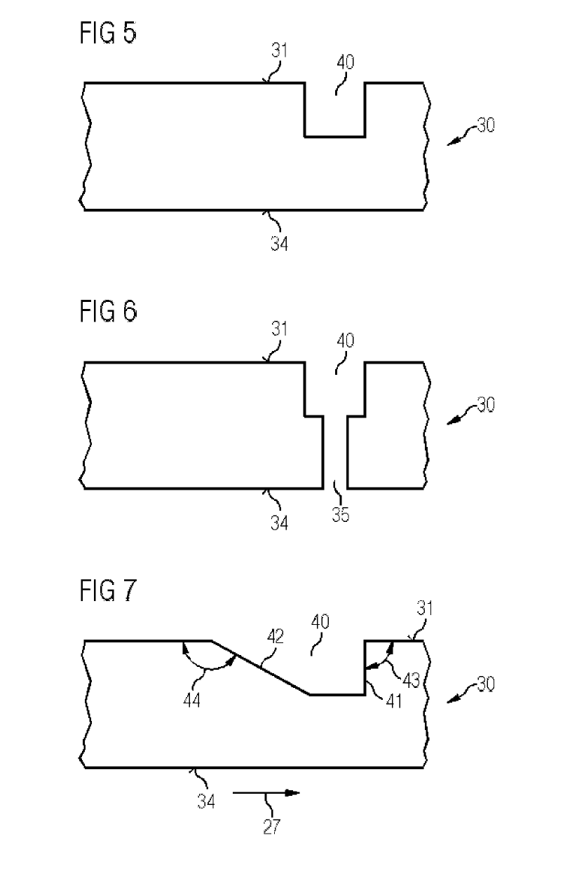

FIG. 6 shows the same sliding lining 30 in a second cross section. The second cross section is selected such that a sliding lining duct 35 of the sliding lining 30 can be seen. The sliding lining duct 35 runs essentially perpendicular with respect to the contact face 31 or with respect to the attachment face 34 and has a diameter which is smaller than a width of the groove 40.

FIG. 7 shows a further sliding lining 30 in a cross section. The sliding lining 30 has a groove 40 which has a front groove wall 41 and a rear groove wall 42. The difference between the front groove wall 41 and the rear groove wall 42 is effected relative to the rotational direction 27.

It is apparent that the front groove wall 41 encloses an angle of 90° with a contact face 31 of the sliding lining 30. In contrast, the rear groove wall 42 encloses an angle of 135° with the contact face 31. The angle between the front groove wall 41 and the contact face 31 is referred to as the front groove wall inclination angle 43; the angle between the rear groove wall 42 and the contact face 31 is referred to as the rear groove wall inclination angle 44. An inclined rear groove wall 42, shown in FIG. 6, is also referred to as a beveled face or beveled edge.

FIG. 8 shows a sliding lining 30 with a contact face 31, a groove 40 and a sliding lining duct 35 which crosses the sliding lining 30 and is connected to the groove 40. Furthermore, FIG. 7 shows a sliding lining carrier 37 which is crossed by a sliding lining carrier duct 38. The sliding lining 30 is connected to the sliding lining carrier 37. In the exemplary embodiment shown in FIG. 7, the sliding lining 30 is clamped tight to the sliding lining carrier 37.

In order to efficiently feed lubricant into the groove 40, the sliding lining duct 35 and the sliding lining carrier duct 38 are connected to one another in a flush fashion.

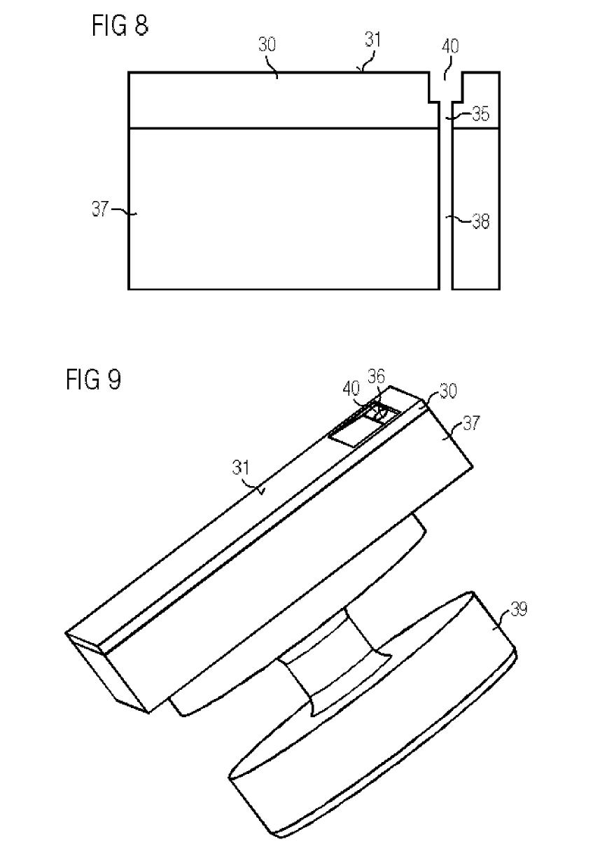

FIG. 9 finally shows a sliding lining 30 with a contact face 31, a groove 40 and a sliding lining duct opening 36 which is connected to a sliding lining carrier 37. The sliding lining carrier 37 is in turn connected to a rotary joint 39. The rotary joint 39 permits the sliding lining 30 to be oriented in the sliding bearing 20 by virtue of the fact that the rotary joint 39 can rotate about a center of rotation. The rotary joint 39 can in turn be attached, for example, to an outer side of an inner bearing ring 24.

1. A wind power plant comprising:
a sliding bearing, wherein the sliding bearing comprises:
a first bearing component and a second bearing component,
the first bearing component and the second bearing component are arranged such that they can rotate relative to one another about a common rotational axis,
the sliding bearing has at least one sliding lining which is arranged between the first bearing component and the second bearing component,
the sliding lining has a contact face which is provided for contact with a lubricant,
the contact face has a sliding lining duct opening to a sliding lining duct, wherein the sliding lining duct crosses the sliding lining and is provided for feeding lubricant into a region between the first bearing component and the second bearing component, and
the sliding lining has a groove on the contact face, and the groove surrounds the sliding lining duct opening.

2. The wind power plant as claimed in claim 1, wherein the sliding bearing is a radial bearing and/or an axial bearing.

3. The wind power plant as claimed in claim 1, wherein
the sliding bearing has a rotational direction which is defined by the first bearing component and the second bearing component which can rotate relative to one another,
the contact face has a contact face region at the front in the rotational direction and a contact face region at the rear in the rotational direction, and
the groove is located in the front contact face region.

4. The wind power plant as claimed in claim 3, wherein
the groove has a groove wall at the front in the rotational direction and a groove wall at the rear in the rotational direction,
the front groove wall has a front groove wall inclination angle between the front groove wall and the contact face,
the rear groove wall has a rear groove wall inclination angle between the rear groove wall and the contact face, and
the front groove wall inclination angle is smaller than the rear groove wall inclination angle.

5. The wind power plant as claimed in claim 1, wherein
the sliding bearing has a sliding lining carrier which is connected to the sliding lining,
the sliding lining carrier has a sliding lining carrier duct which crosses the sliding lining carrier, and
the sliding lining carrier duct is provided for feeding lubricant into the sliding lining duct.

6. The wind power plant as claimed in claim 5, wherein the sliding lining carrier is arranged, by a rotary joint, such that it can rotate relative to the first bearing component and/or can rotate relative to the second bearing component.

7. The wind power plant as claimed in claim 5, wherein the sliding lining carrier and/or the sliding lining are/is flexible.

8. The wind power plant as claimed in claim 5, wherein the sliding lining carrier comprises a sliding lining carrier material which has iron.

9. The wind power plant as claimed in claim 1, wherein
the wind power plant has a rotor and a gondola, and
the sliding bearing is a main bearing for rotatably bearing the rotor relative to the gondola.

10. The wind power plant as claimed in claim 1, wherein the lubricant has a lubricating oil.

11. The wind power plant as claimed in claim 1, wherein the sliding lining comprises a sliding lining material which has a polymer and/or a white metal.

12. A method of operation of a wind power plant, comprising:
generating electric current with a wind power plant of claim 1.

13. The method of operation of a wind power plant as claimed in claim 12, wherein
the sliding bearing is operated hydrostatically during a startup phase of the rotational movement, and/or
the sliding bearing is operated hydrodynamically during a phase of the rotational movement with a constant rotational speed

14. The wind power plant as claimed in claim 5, wherein the sliding lining carrier comprises a sliding lining carrier material comprising an iron alloy.
